(19) United States
(12) Patent Application Publication
(10) Pub. No.: US 2003/0174827 A1
(43) Pub. Date: Sep. 18, 2003

(54) Method for determining a service providing program, associated units and associated program

(76) Inventor: Volker Henz, Unterschleissheim (DE)

Correspondence Address: Kevin R. Spivak, Morrison & Foerster LLP, Suite 300, 1650 Tysons Boulevard, McLean, VA, 22102, US

(21) Appl. No.: 10/339,646

(22) Filed: Jan. 10, 2003

(30) Foreign Application Priority Data
Jan. 11, 2002 (EP) 02000724.1

(51) Int. Cl. H04M 7/00

(52) U.S. Cl. 379/220.01; 379/221.14

(57) ABSTRACT

The invention relates, inter alia, to a method in which an identifier is assigned to a terminal, said identifier being independent of an operator who operates the terminal. In a switching device, the identifier is used to determine a service providing program by means of which a communications service can be used from the terminal. For the service providing program which is determined, settings are then made as a function of the operator who operates the terminal.

### CLAIM FOR PRIORITY

This application claims priority to Application No. 02000724.1 which was filed in the German language on Jan. 11, 2002.

### TECHNICAL FIELD OF THE INVENTION

The invention relates to a method for determining a service providing program which provides a communications service for a terminal.

### BACKGROUND OF THE INVENTION

The service providing program is adapted to the terminal and provides communications services according to the client-server principle. Examples of communications services are the transmission of voice data within the scope of telephone services or a call distribution system.

The object of the invention is to specify, for the purpose of determining a service providing program, a simple method which permits new service features to be introduced or known service features to be used in a relatively large application area. In addition, an associated terminal, an associated switching device and an associated program are to be specified.

The object which relates to the method is achieved by means of the method steps specified in patent claim 1. Developments are given in the subclaims.

In the method according to the invention, an identifier which is independent of an operator who operates the terminal is assigned to the terminal. The identifier is transmitted to a switching device from the terminal. As a function of the identifier, a service providing program which provides a communications service for the terminal and has been adapted both for the type of terminal and also for this specific terminal in a configuration procedure is determined in the switching device. Settings are made for the service providing program as a function of the operator who operates the terminal. These settings relate, for example, to the call number at which the terminal can be accessed, to service features which are enabled for the terminal or to billing information.

The method according to the invention makes it possible to define new service features and to construct the associated functional units. In addition, as explained below in conjunction with developments, known service features can also be transferred to a larger application area, for example the free seating service feature may also be used for terminals which are in a data packet transmission network and to which no fixed connection has been assigned in a switching device.

In one development of the method according to the invention, the operator selects the terminal from at least two terminals for which the operator has a free seating feature for the use of a communications service. For example, the communications service can be used to the same extent from two terminals, for example from a terminal in a company and from a terminal at home.

In another development of the method according to the invention, the communications service is a call distribution function which forwards calls arriving at a collective number to at least one terminal of a group of terminals, which group also includes the terminal which is used by the operator. The call distribution function is also referred to as Automatic Call Distribution (ACD).

In another development, in the switching device a transmission channel is connected to another transmission channel which comes from the terminal or leads to the terminal. In the development, the terminal is a terminal of a data packet transmission network to which useful data is transmitted via the line with the intermediate connection of a network gateway, and/or which transmits useful data to the service providing computer with the intermediate connection of a network gateway. In the development, two basically different types of switching are combined. While connections are set up on all protocol levels in a line switching operation, connections are made only at upper protocol levels during the transmission of data packets. The data packets each contain a destination address so that at lower protocol levels it is possible to forward the data packets without setting up connections. The development ensures that methods which are specified for the line-switched telephone network, for example, can be used essentially without modification even if the terminal is in a data packet transmission network. In particular, the inclusion of terminal-specific service providing programs is retained, and this is associated in the line-switched network with a series of advantages, for example with simple signaling methods.

In another development, the service providing program is an entity of a program. Here, one instruction sequence is used by a plurality of entities. Each entity is assigned its own data. Furthermore, the current version status is noted for each entity.

In one development of the method according to the invention, a call number at which the terminal can be accessed is transmitted to the switching device from the terminal. The transmitted call number is assigned to the service providing program. The call number is assigned to an operator as an alternative or in a cumulative fashion. The development ensures that, in spite of a free seating feature, the operator can be accessed at the same call number. Furthermore, a large number of service features are tied to call numbers, for example the billing.

In one development, a signaling message which comes from the terminal and which contains a signaling data item which has been defined for a service feature is forwarded to the service providing program which is determined. As a result, signaling messages are easily assigned to the service providing program.

In another development, the identifier is stored in the terminal and is transmitted to the switching device within the context of a signing on procedure of an operator for the use of the communications service. As the identifier is independent of the operator, as a result of the development the operator is not burdened with inputting said identifier.

In another development, the identifier is transmitted in the data packet transmission network in a signaling data item which is not evaluated in the data packet transmission network. In this context, the term used is tunneling or transparent data transmission.

If, in another development, the signaling message is a signaling message according to a protocol of the protocol group which is associated with the Standard H.323 of the ITU-T (International Telecommunication Union—Telecommunication Sector), the signaling data item is transmitted in an information element which is referred to as “nonStandardControl” in the Standard H.225.0 02/98, Annex H, H.323 UU-PDU. A data field “nonStandardData” is in fact often already assigned for conveying other signaling messages for the provision of the communications service. As a result of the development, standardized forwarding is achieved in a simple way.

In another development, the identifier is an identifying means for a program which is used in the terminal or for a piece of hardware used in the terminal. For example, the identifier is what is referred to as a console ID (identification) of console programs. For example Siemens AG provides the console programs MAC (Multifunctional Attended Console) and MSB (Multifunction Switch Board) which can be used to set up what is referred to as an agent work station at the terminal within the scope of a call distribution system.

The invention also relates to a terminal, a switching device and a program which can be used to execute the method according to the invention or one of its developments. The technical effects mentioned above therefore also apply to the terminal, to the switching device and to the program.

### BRIEF DESCRIPTION OF THE DRAWINGS

Exemplary embodiments of the invention are explained below with reference to the appended drawings, in which:

FIG. 1 shows units which are used for a call distribution system on the Internet and in a telephone network.

FIG. 2 shows messages for signing on an operator with a call distribution program.

FIG. 3 shows messages with which the reception of a request for signing on is confirmed.

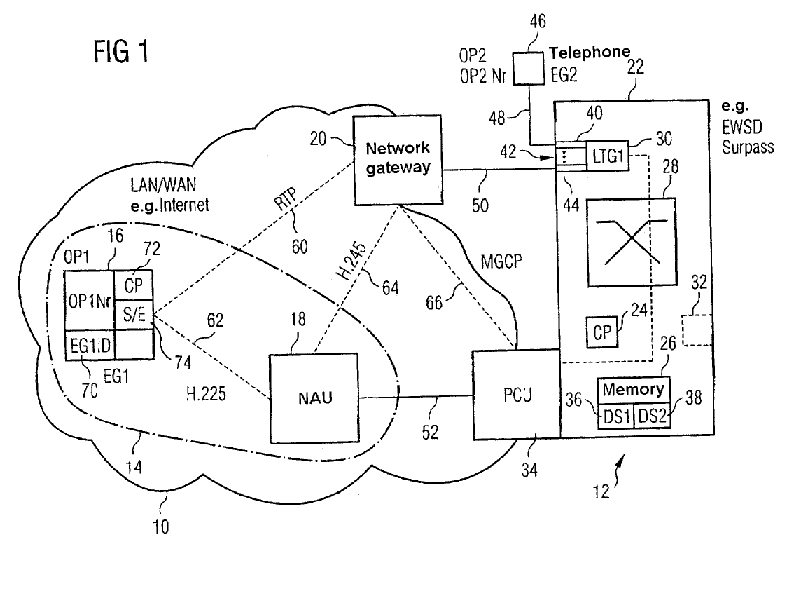

FIG. 1 shows units which are used for a call distribution system on the Internet 10 and in a line-switched telephone network 12. On the Internet 10, data packets are transmitted in accordance with an Internet protocol, for example according to TCP (Transmission Control Protocol) at lower protocol levels. At upper protocol levels, for example protocols of the H.323 protocol group are used, in particular the protocols according to Standard H.225 and according to Standard H.245. A subnetwork 14 of the Internet 10 contains a terminal 16 which is an H.323 terminal, and a network gateway 18 which is also referred to as a gatekeeper. A network gateway 20 forms an interface between the Internet 10 and the telephone network 12. The network gateway 20 is also referred to as gateway.

The telephone network 12 is, for example, the line-switched telephone network of Deutsche Telekom AG and contains a switching office 22, for example of the EWSD type or of the Surpass type from Siemens AG. The switching office 22 has been expanded with the functions mentioned below in order to provide the method according to the invention.

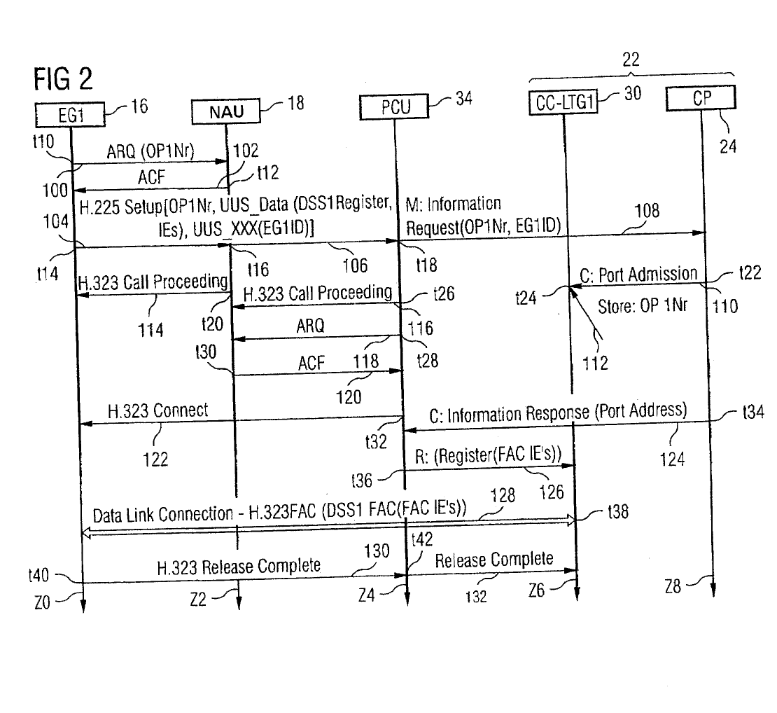

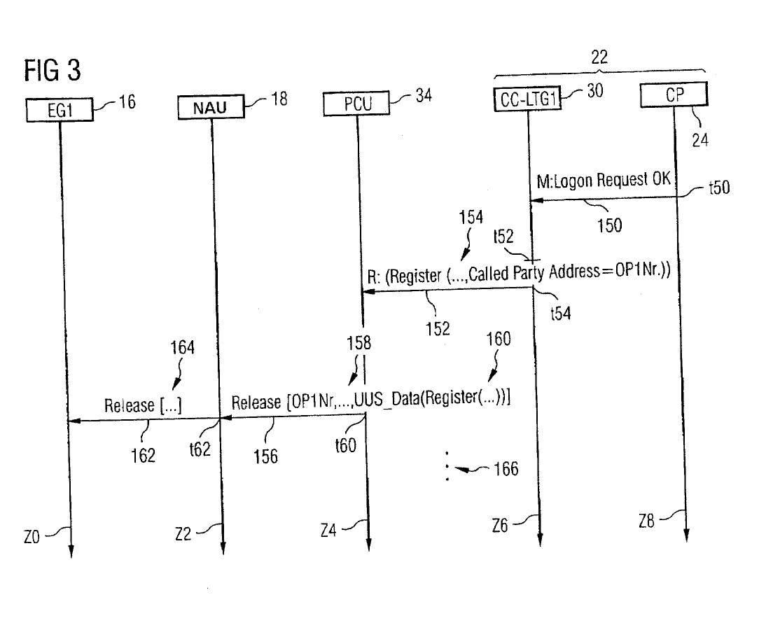

The switching office 22 contains a central processor 24, a storage unit 26, a switching matrix 28, subscriber line modules 30 and 32 and a packet network control unit 34. The central processor 24 performs central control functions which have been explained in more detail below in conjunction with FIGS. 2 and 3 in so far as they are significant for the invention. In the storage unit 26 programs are stored which are required for the execution of the central control function. Furthermore, data records 36 and 38 which are assigned in this order to an operator OP1 and an operator OP2 which may be involved in a call distribution system are stored in the storage unit 26. Data which specifies the service features which can be used by the operators OP1 and OP2, in particular within the scope of the call distribution system, are stored in the data records 36, 38.

Transmission channels from the subscriber line modules 30 and 32 or leading to these subscriber line modules are connected in the switching matrix 28 under the control of the central processor 24.

The subscriber line module 30 is also referred to as a line trunk group (LTG) and contains a local control unit and a local storage unit which are however not illustrated in FIG. 1. At the subscriber line module 30 there are service providing programs 40 to 44 which are each assigned to a terminal. A first service providing program 40 is assigned, for example, to a telephone 46. The terminal 46 is connected to the subscriber line module 30 via an ISDN (Integrated Services Digital Network) subscriber line 48. What is referred to as a console program is executed at the terminal 46. The service providing program 44 provides functions for the call distribution service for the terminal 16.

A transmission line 50 leads from the subscriber line module 30 to the network gateway 20. The terminal 16 can be accessed via the transmission line 50. The subscriber line module 32 is used to connect other terminals, inter alia also to connect terminals which are involved in the call distribution system.

The packet network control unit 34 is connected to the network gateway 18 via a transmission line 52. Functions of the packet network control unit 34 are explained below in more detail in conjunction with FIGS. 2 and 3.

On the Internet 10, the following protocols are used for transmitting data at higher protocol levels:

the protocol RTP (Transport Protocol for Real-Time Applications) of the IETF (Internet Engineering Task Force) between the terminal 16 and the network gateway 20, see dashed line 60,

the protocol according to Standard H.225 of the ITU-T between the terminal 16 and the network gateway 18, see dashed line 62,

the protocol according to Standard H.245 of the ITU-T between the network gateway 20 and the network access unit 18, see dashed line 64, and

the protocol MGCP (Media Gateway Control Protocol) of the IETF (Internet Engineering Task Force) between the network gateway 20 and the packet network control unit 34, see dashed line 66.

However, other protocols can also be used, for example the protocol SIP (Session Initiation Protocol) can be used instead of the protocol H.225, and the protocol according to Standard H.248 can be used instead of the protocol MGCP.

A call distribution function is generated using the central processor 24 and using service providing programs 40 to 46 which are executed on the subscriber line modules 30 and 32. In the exemplary embodiment, the operator OP1 firstly uses the terminal 16 within the scope of the call distribution system. In contrast, the operator OP2 firstly uses the terminal 46. Each operator OP1, OP2 is assigned an operator number OP1Nr or OP2Nr which also includes a call number at which the respective operator OP1 or OP2 can be accessed within the scope of the call distribution system. The operator number OP1Nr or OP2Nr contains, for example, a call number which fulfills the Standard E.164 of the ITU-T. The terminal 16 is also assigned a terminal number EG1ID which is stored in a storage unit 70 of the terminal 16. The terminal number EG1ID uniquely identifies the terminal 16 and was allocated in the switching office 22 only once when the respective console programs were registered. Furthermore, the terminal 16 contains a processor 72 and a transmitter and receiver unit 74.

On the other hand, the terminal 46 is not assigned a terminal number EGID because the terminal 46 is connected to the subscriber line module 30 via a subscriber line 48. The service providing program 40 is therefore defined as a receiver of the signaling data coming from the terminal 46. The method for determining the connection 44 as a receiver of the signaling data coming from the terminal 16 is explained in more detail below with reference to FIGS. 2 and 3.

However, the operators OP1 and OP2 have the possibility of the free seating feature so that they can use either the terminal 46 or the terminal 16. The operator OP1 or OP2 carries out in each case a signing on procedure in which he identifies himself and receives access authorization, for example after inputting a password. The procedures which are associated with the signing on procedure are also explained below with reference to FIG. 2.

FIG. 2 shows messages which are executed during the signing on of the operator OP1 into the call distribution program, in particular the service providing program 44.

Time traces Z0, Z2, Z4, Z6 and Z8 are assigned in this order to procedures which relate to the terminal 16, the network access unit 18, the packet network control unit 34, the subscriber line module 30 and the central processor 24, respectively. Identical times are represented on the time traces Z0 to Z8 at the same level. Earlier times are represented higher up than later times.

The operator OP1 sits down at the terminal 10 and starts a console program which he can use to become involved in a call distribution system. The console program requests him to input his operator number OP1Nr.

At a time t10, the terminal 16 generates an access request message 100 which is also referred to as ARQ (Admission Request). The access request message 100 is directed at the network access unit 18 and contains the operator number OP1Nr which corresponds to a call number at which the terminal 16 is to be accessible within the scope of the call distribution system.

The network access unit 18 responds to the access request message 100 in accordance with the protocol at a time t12 with an access confirmation message 102. The access confirmation message 102 is also referred to as ACF (Admission Confirm) and is directed at the terminal 16.

At a time t14, the terminal 16 generates a connection setup message 104 which contains the operator number OP1Nr. Furthermore, the connection setup message 104 contains, in a data field UUS_Data, a registration message in accordance with the subscriber signaling protocol DSS1 (Digital Signaling System Number One). The registration message contains information elements which are used to request registration within the scope of the call distribution system. The data field UUS_Data is not evaluated on the Internet 10. Furthermore, the connection setup message 104 contains a data field UUS_XXX which contains the terminal number EG1ID. The data field UUS_XXX is also not evaluated on the Internet 10 but rather transmitted transparently. The connection setup message 104 is directed at the network access unit 18. The data field UUS_Data is referred to as nonStandardData according to Standard H.225.0. On the other hand, the data field UUS_XXX is referred to as nonStandardControl according to Standard H.225.0.

The network access unit 18 forwards the connection setup message 104 essentially without modification as a connection setup message 106 to the packet network control unit 34 at a time t16. The network access unit 18 does not carry out switching as the packet network control unit 34 of the network access unit 18 is permanently assigned.

The packet network control unit 34 reads the data fields UUS_Data and UUS_XXX. On the basis of the content of these data fields, the packet network control unit 34 generates, at a time t18, an information request message 108 which contains the operator number OP1Nr and the terminal identifier EG1ID. The information request message 108 is sent to the central processor 24 at a time t18. The central processor 24 brings about the processing of the information request message 108 and in doing so also determines a free time slot on the transmission line 50. Using a table stored in the storage unit 26 and using the terminal identifier EG1ID, the central processor 24 recognizes the service providing program 44 as the service providing program which has been assigned to the terminal 16, i.e. the terminal with the terminal identifier EG1ID. The address of the service providing program 44 or an identifier for the service providing program 44 also contains an identifier for the subscriber line module 30. For this reason, the central processor 24 directs, at a time t22, a seizure message 110 to the subscriber line module 30 which is used to call the service providing program 44. Furthermore, the seizure message 110 contains the operator number OP1Nr. The operator number OP1Nr is stored as being associated with the service providing program 44, in the subscriber line module 30 at a time t24. The storage of the operator number OP1Nr is indicated in FIG. 2 by an arrow 112. The central processor 24 also notes that the service providing program 44 is associated with the operator number OP1Nr at that particular time.

In the meantime, at a time t20, the network access unit 18 generates, as a further reaction to the connection setup message 104, a continuation message 114 which is used to signal to the terminal 16 that the network access unit 18 is setting up a signaling connection. The continuation message 114 is also referred to as a call proceeding message.

The packet network control unit 34 also generates, as a further reaction to the connection setup message 106, a continuation message 116 which is used to signal to the network access unit 18 that the packet network control unit 34 has also brought about the connection setup. At a time t28, the packet network control unit 34 generates, in accordance with the standard, an access request message 118 which is also referred to as ARQ message and which is directed at the network access unit 18. The network access unit 18 confirms the access authorization at a time t30 with an access confirmation message 120. After the reception of the access confirmation message 120, there is a signaling connection between the packet network control unit 34 and the terminal 16. For this reason, according to the standard the packet network control unit 34 transmits a connection message 122 to the terminal 16 at a time t32. The connection message 122 is also referred to as connect message.

At a time t34, the central processor 24 generates an information response message 124 for the packet network control unit 34. The information response message contains the address of the service providing program 44.

Owing to the service providing program address, transmitted in the information response message 124, of the service providing program 144, the packet network control unit 34 is capable of sending the registration request received with the connection setup message 106 to the subscriber line module 30. For this purpose, a registration message 126 is sent, at a time t36, to the subscriber line module 30 in which the information elements, contained in the connection setup message 106, of the registration message are also given.

During the evaluation of the registration message 126 in the subscriber line module 30 via the service providing program 44 it is detected that a signing on procedure is requested within the scope of the call distribution system. Owing to the association between service providing program 44 and terminal 16, it is also known that the packet network control unit 34 is to be included in the signaling. There is thus a signaling connection 118 between the subscriber line module 30 and the terminal 16. Via the signaling connection 118, the subscriber line module 30 sends messages which could also be intended for transmission to the terminal 46 within the scope of a signing on procedure for the call distribution system. Messages are transmitted transparently from the packet network control unit 34 to the terminal 16 and evaluated there.

In the exemplary embodiment, firstly it is only signaled, via the signaling connection 118, that the signing on procedure has been initiated without faults. The method steps which are executed in the process are explained in more detail below with reference to FIG. 3.

After the reception of a confirmation for the error-free initiation of the signing on procedure, the terminal 16 generates, at a time t40, a triggering confirmation message 130 which is directed at the packet network control unit 34. The triggering confirmation message 130 is also referred to as a release-complete message. Owing to the reception of the triggering confirmation message 130, the packet network control unit 34 itself generates a triggering confirmation message 132 at a time t42, which triggering confirmation message 132 is directed at the subscriber line module 30, to be more precise at the service providing program 44.

FIG. 3 shows messages which confirm the reception of a request for the initiation of a signing on procedure. The central processor 24 generates, at a time t50, a confirmation message 150 which is directed at the subscriber line module 30, to be more precise at the service providing program 44. The confirmation message 150 is also referred to as a LogonRequestOK message. When the confirmation message 150 is processed in the subscriber line module 30, the service providing program 44 reads, at a time t52, the call number which is stored for the service providing program 44, i.e. the operator number OP1Nr. At a time t54, the service providing program 44 generates a registration message 152 which is used to confirm the error-free initiation of the signing on procedure, see data fields 154. Furthermore, the registration message 152 contains a data field in which the operator number OP1Nr is given as a call number to be called. The registration message 152 is directed at the packet network control unit 34.

When the registration message 152 is processed, the packet network control unit 34 generates a triggering message 156 which is also referred to as release message. The objective of the triggering message 156 is to specify the operator number OP1Nr. Furthermore, the triggering message 156 contains further standard data fields 158. In one data field UUS_Data, the registration message 152 is transmitted, including its data fields 160, in a transparent form. The triggering message 156 is directed at the network access unit 18.

When the triggering message 156 is processed, the network access unit 18 also generates a triggering message 162 at a time t62, which triggering message 162 contains essentially the same data fields 164 as the triggering message 156. When the triggering message 162 is processed in the terminal 16, the method steps already explained above are executed in order to generate the triggering confirmation message 130.

In FIG. 3, further method steps 166 with which the involvement of the terminal 16 in the call distribution system is executed are indicated by means of points. Here, inter alia, the data of the data record 36, i.e. the data of the data record which is assigned to the operator OP1, are transmitted from the central processor 24 to the service providing program 44, i.e. to the service providing program which executes the call distribution system for the terminal 16. The data of the data record 36 is stored on the subscriber line module 30 as configuration data of the service providing program 44. The service providing program 44 brings about the transmission of the data of the data record 36 to the terminal 16. The error-free transmission of the data is confirmed by the terminal 16. At each subsequent signaling operation, the terminal identifier EG1ID is also transmitted from the terminal EG1 to the switching office 22 in order to permit the assignment of the messages to the service providing program 44.

If calls are forwarded to the service providing program 44 within the scope of the call distribution system, a connection can be set up for transmitting voice data over the transmission line 50 and the Internet 10 to the terminal 16, see dashed line 60. In order to set up the connection for the transmission of useful data, the necessary signaling operations are brought about by the packet network control unit 34 and by the network access unit 18, see dashed lines 64 and 66 in FIG. 1.

If the operator OP1 is no longer ready to accept a call within the scope of the call distribution system, it signs off again from the call distribution program. At the next signing on it has a free seating feature again and selects, for example, the terminal 46 as work station in order to receive calls within the scope of the call distribution system.

In another exemplary embodiment, the terminal 16 has a connection to the Internet via what is referred to as an Internet service provider. This means that the terminal 16 does not have a fixed Internet address, but rather an Internet address which is automatically allocated whenever it dials into the Internet 10. But in this case also the method explained above can also be executed without modification owing to the terminal identifier EG1ID which always remains the same.

1. A method for determining a service providing program (44),
in which an identifier (EG1ID) is assigned to a terminal (16), said identifier (EG1ID) being independent of an operator (OP1, OP2) which operates the terminal (16),
in which the identifier (EG1ID) is transmitted to a switching device (22) from the terminal (16),
in which a service providing program (44) which provides at least one communications service for the terminal (16) is determined as a function of the identifier (EG1ID) in a switching device (22),
and in which settings are made for the service providing program (44) as a function of the operator (OP1, OP2) who operates the terminal (16).

2. The method as claimed in claim 1, characterized in that the operator (OP1, OP2) selects the terminal (16) from at least two terminals (16, 46) for which he has a free seating feature for the use of the communications service.

3. The method as claimed in claim 2, characterized in that the communications service relates to a call distribution function which forwards calls arriving at a collective number to at least one terminal (16) of a group of terminals (16, 46), the group also including the terminal (16) which is used by the operator (OP1).

4. The method as claimed in claim 1, characterized in that, in the switching device (22) for providing the communications service, a transmission channel is connected to another transmission channel (28) which comes from the terminal (16) or leads to the terminal (16),
and in that the terminal (16) is a terminal (16) of a data packet transmission network (10) to which, during the provision of the communications service, useful data, preferably voice data, is transmitted using the service providing program (44) with the intermediate connection of a network gateway (20), and/or in that, during the use of the communications service, useful data, preferably voice data, transmits to the service providing program (44) with the intermediate connection of the network gateway (20).

5. The method as claimed in claim 1, characterized in that the service providing program (44) is an entity of a program.

6. The method as claimed in claim 1, characterized in that a call identifier (OP1Nr) at which the terminal (16) can be access is transmitted to the switching device (22) from the terminal (16),
and in that the transmitted call identifier (OP1Nr) is assigned to the service providing program (44) which is determined,
and/or in that the call identifier (OP1Nr) is assigned to the operator (OP1).

7. The method as claimed in claim 1, characterized in that a signaling message (126) which comes from the terminal (16) is forwarded to the service providing program (44) which is determined.

8. The method as claimed in claim 1, characterized in that the identifier (EG1ID) is stored (70) in the terminal (16),
and/or in that the identifier (EG1ID) is transmitted to the switching device (22) within the context of a signing on procedure of the operator (OP1) for the use of the communications service.

9. The method as claimed in claim 4, characterized in that, in the data packet transmission network (10), the identifier (EG1ID) is transmitted in a signaling data item which is not evaluated in the data packet transmission network (10).

10. The method as claimed in claim 9, characterized in that the identifier (EG1ID) is transmitted in a signaling message according to Standard H.225 or according to a standard which is based on this standard, in a data element which is provided for a user-to-user communication, preferably in a data element with the name nonStandardData or nonStandardControl.

11. The method as claimed in claim 9, characterized in that the identifier (EG1ID) is a means of identifying a program which is used for the communications service in the terminal (16) and/or a switching unit which is utilized in the terminal (16).

12. A terminal (16),
having a transmitter unit (74) for transmitting an identifier (EG1ID) to a switching device (22),
and having a control unit (72) which generates signaling messages which are transmitted by the transmitter unit (74),
characterized in that the control unit (72) generates a signaling message (104) which contains an identifier for the terminal (16), said identifier being independent of an operator (OP1, OP2) who operates the terminal (16), and said identifier being used, in a switching device (22), to determine a service providing program (44) which provides at least one communications service for the terminal (16).

13. The terminal (16) as claimed in claim 12,
characterized in that the terminal (16) contains at least one further unit which permits a method as claimed in one of claims 1 to 11 to be executed.

14. A switching device (22) for determining a connection (44),
having a service providing program (44) which provides at least one communications service for a terminal (16),
having a receiver unit (34) which receives signaling messages,
and having a control unit (24, 30) which processes the received signaling messages,
characterized in that the control unit (24, 30) evaluates an identifier (EG1ID) which is received via the receiver unit (34), has been assigned to the terminal (16) and is independent of an operator (OP1, OP2) who operates the terminal (16),
and in that the control unit (24, 30) determines the service providing program (44) as a function of the identifier (EG1ID).

15. The switching device (22) as claimed in claim 14, characterized in that the switching device (22) contains at least one further unit which permits a method as claimed in one of claims 1 to 11 to be executed.

16. A program having an instruction sequence which can be executed by a processor (24, 32), characterized in that the method steps of a method as claimed in claim 1, which relate to the terminal (16) or those which relate to the switching device (22) are executed during the execution of the program.
